(19) United States
(12) Patent Application Publication
(10) Pub. No.: US 2015/0259585 A1
(43) Pub. Date: Sep. 17, 2015

(54) TWO-PART CURABLE LIQUID SILICONE RUBBER COMPOSITION

(71) Applicant: DOW CORNING TORAY CO., LTD., Tokyo (JP)

(72) Inventors: Tomoko Tasaki, Chiba (JP); Yuichi Tsuji, Chiba (JP)

(21) Appl. No.: 14/418,466

(22) PCT Filed: Jul. 29, 2013
(86) PCT No.: PCT/JP2013/071090

§ 371 Date: Jan. 30, 2015

(30) Foreign Application Priority Data
Jul. 30, 2012 (JP) 2012-168106

(51) Int. Cl. C09J 183/06; C08K 3/26

(52) U.S. Cl. CPC C09J 183/06; C08K 3/26; C08K 2003/265

(57) ABSTRACT

A two-part curable liquid silicone rubber composition is composed of a first liquid composition and a second liquid composition, which are stored separately and yield upon mixing a silicone rubber-forming composition. The silicone rubber-forming composition comprises: (A) a diorganopolysiloxane having an average of at least 2 alkenyl groups in a molecule; (B) a silicon-bonded hydrogen atom-containing organopolysiloxane composed of (B-1) an organopolysiloxane having an average of not more than 2 silicon-bonded hydrogen atoms in a molecule only in side molecular chains and (B-2) an organopolysiloxane having 2 silicon-bonded hydrogen atoms only at both molecular terminals; (C) a calcium carbonate powder; and (D) a platinum-based catalyst. The two-part curable liquid silicone rubber composition provides a cured product with suppressed fluctuations of properties even if the mixing ratio of a first composition and a second composition is changed.

### TECHNICAL FIELD

The present invention relates to a two-part curable liquid silicone rubber composition composed of a first composition and a second composition, which are stored separately and yield upon mixing a silicone rubber forming composition.

Priority is claimed on Japanese Patent Application No. 2012-168106, filed on Jul. 30, 2012, the content of which is incorporated herein by reference.

### BACKGROUND ART

In silicone rubber compositions which contain a calcium carbonate powder and which are cured by a hydrosilylation reaction, the calcium carbonate powder contains alkaline components as impurities, and therefore involve problems such as hydrogen gas being generated during storage due to reactions with organopolysiloxanes having silicon-bonded hydrogen atoms, which are contained as curing agents in the composition. As a result, for example, silicone rubber compositions comprising a diorganopolysiloxane having at least 2 alkenyl groups in a molecule, a calcium carbonate powder substantially surface treated with a diorganopolysiloxane, an organopolysiloxane having at least 2 silicon-bonded hydrogen atoms in a molecule and a platinum group metal-type catalyst have been proposed (see Japanese Unexamined Patent Application Publication No. 2002-38016).

In such cases, storing an addition reaction curable silicone rubber composition as two components is a commonly used means, and storing a calcium carbonate-containing addition reaction curable silicone rubber composition as two components has also been proposed. In addition, Japanese Unexamined Patent Application Publication No. 2002-38016 proposes a two-part composition composed of a first liquid, which contains an alkenyl groups-containing diorganopolysiloxane and calcium carbonate surface treated with a diorganopolysiloxane, and a second liquid, which contains an organohydrogenpolysiloxane, a platinum group metal-type catalyst and an adhesion-imparting agent.

Japanese Unexamined Patent Application Publication Nos. 2006-117823, 2006-335872 and 2010-163478 indicate that by not blending calcium carbonate in a liquid that contains an organohydrogenpolysiloxane having an average of 2 or more silicon-bonded hydrogen atoms in a molecule, a composition that contains a curing agent undergoes little change in viscosity even when two liquids are stored for long periods, these liquids can be uniformly mixed at a volume ratio of 1:1 by means of a motionless mixer such as a static mixer, and it is possible to provide a two-liquid silicone rubber composition able to achieve the initially designed physical properties of a silicone rubber and adhesive properties to a silicone rubber.

However, there is no recitation in any of these Patent Documents regarding changes in physical properties and/or adhesion in cases where the volume ratio, upon mixing, when forming a silicone rubber forming composition by mixing the separately stored first composition and second composition, varies.

An object of the present invention is to provide a two-part curable liquid silicone rubber composition composed of a first composition and a second composition that are stored separately, in which the physical properties and the adhesion to silicone rubber of a cured product thereof do not decline when mixed even in cases where a mixture ratio of the first composition to the second composition varies.

### DISCLOSURE OF INVENTION

A two-part curable liquid silicone rubber composition of the present invention is composed of a first liquid composition and a second liquid composition, which are stored separately and yield upon mixing a silicone rubber forming composition comprising:
(A) 100 parts by mass of a diorganopolysiloxane having an average of at least 2 alkenyl groups in a molecule;
(B) a silicon-bonded hydrogen atom-containing organopolysiloxane composed of (B-1) and (B-2) described below in an amount such that a molar ratio of silicon-bonded hydrogen atoms in component (B) relative to alkenyl groups in component (A) is from 0.01 to 20;
   (B-1) an organopolysiloxane having an average of not more than 2 silicon-bonded hydrogen atoms in a molecule only in side molecular chains in an amount such that a molar ratio of silicon-bonded hydrogen atoms in component (B-1) relative to silicon-bonded hydrogen atoms in component (B) is from 0.05 to 1.00,
   (B-2) an organopolysiloxane having 2 silicon-bonded hydrogen atoms only at both molecular terminals in an amount such that a molar ratio of silicon-bonded hydrogen atoms in component (B-2) relative to silicon-bonded hydrogen atoms in component (B) is from 0.00 to 0.95,
(C) from 1 to 200 parts by mass of a calcium carbonate powder; and
(D) a platinum-based catalyst in an amount required to cure the present composition, the first liquid composition comprising components (A), (C), and (D), but not (B-1) and (B-2), and the second liquid composition comprising components (A), (B-1), (B-2), and (C), but not (D).

Component (C) is preferably a light or precipitated calcium carbonate powder.

Furthermore, the first composition and/or the second composition preferably comprises (E) an amorphous silica powder in an amount of from 0.1 to 100 parts by mass per 100 parts by mass of component (A).

The two-part curable liquid silicone rubber composition described above is useful as an adhesive or sealer for a silicone rubber coated fabric.

### EFFECTS OF INVENTION

With the two-part curable liquid silicone rubber composition of the present invention, the excellent physical properties and the adhesion to silicone rubber of a cured product thereof are maintained upon mixing a first composition and a second composition that are stored separately, even in cases where a mixture ratio of the first composition to the second composition varies.

### DETAILED DESCRIPTION OF THE INVENTION

The two-part curable liquid silicone rubber composition of the present invention is described in detail below.

Component (A) is a main component of the two-part curable liquid silicone rubber composition of the present invention, and is a diorganopolysiloxane having an average of at least 2 alkenyl groups in a molecule. Examples of the alkenyl groups in component (A) include vinyl groups, allyl groups, butenyl groups, pentenyl groups, hexenyl groups, and heptenyl groups. Of these, vinyl groups are preferable. Moreover, examples of silicon-bonded organic groups in component (A) other than alkenyl groups include methyl groups, ethyl groups, propyl groups, butyl groups, pentyl groups, hexyl groups, and similar alkyl groups; phenyl groups, tolyl groups, xylyl groups, and similar aryl groups; and 3-chloropropyl groups, 3,3,3-trifluoropropyl groups, and similar halogenated alkyl groups. Of these, methyl groups and phenyl groups are preferable. A molecular structure of component (A) is substantially straight, but a portion of the molecular chain may be partially branched provided that the object of the present invention is not inhibited. A viscosity at 25° C. of component (A) is not limited, but is preferably in a range from 100 to 1,000,000 mPa·s, and more preferably in a range from 100 to 500,000 mPa·s.

Examples of the diorganopolysiloxane for component (A) described above include dimethylpolysiloxanes capped at both molecular terminals with dimethylvinylsiloxy groups, copolymers of dimethylsiloxane and methylvinylsiloxane capped at both molecular terminals with dimethylvinylsiloxy groups; copolymers of dimethylsiloxane and methylvinylsiloxane capped at both molecular terminals with trimethylsiloxy groups; diorganopolysiloxanes in which a part or all of the methyl groups thereof are substituted by ethyl groups, propyl groups, or similar alkyl groups, phenyl groups, tolyl groups, or similar aryl groups, 3,3,3-trifluoropropyl groups, or similar halogenated alkyl groups; diorganopolysiloxanes in which a part or all of the vinyl groups thereof are substituted by allyl groups, propenyl groups, or similar alkenyl groups; and mixtures of two or more of the diorganopolysiloxanes described above.

Component (B) is a curing agent which undergoes a crosslinking reaction with component (A) in the presence of component (E), which is described later, so as to crosslink the silicone rubber forming composition of the present invention, and is composed of (B-1) an organopolysiloxane having an average of not more than 2 silicon-bonded hydrogen atoms in a molecule only in side molecular chains, or component (B-1) and (B-2) an organopolysiloxane having 2 silicon-bonded hydrogen atoms only at both molecular terminals. By using such component (B), it is possible to impart the two-part curable liquid silicone rubber composition of the present invention with characteristics such as an obtained cured product undergoing little change in physical properties or adhesive properties to a silicone rubber even if the mixing ratio varies when the separately stored first and second compositions are mixed.

A content of component (B) is an amount such that a molar ratio of silicon-bonded hydrogen atoms in component (B) to alkenyl groups in component (A) is from 0.01 to 20, preferably from 0.1 to 5, and more preferably from 0.5 to 3.

Component (B-1) is an organopolysiloxane having an average of not more than 2 silicon-bonded hydrogen atoms in a molecule only in side molecular chains, preferably has an average of less than 2 silicon-bonded hydrogen atoms in a molecule only in side molecular chains, and more preferably has an average of not less than 1 and less than 2 silicon-bonded hydrogen atoms in a molecule only in side molecular chains. If the average number of silicon-bonded hydrogen atoms in the side molecular chains in component (B-1) exceeds 2, there are concerns that fluctuations will occur in the physical properties and adhesive properties to a silicone rubber of a cured product when fluctuations in the mixing ratio occur when the first composition and the second composition, which are stored separately, are mixed, as described below.

A molecular structure of component (B-1) is not particularly limited, but can be, for example, a resin product having a straight chain, branched chain, cyclic or three dimensional mesh-like structure. Examples of silicon-bonded organic groups in component (B-1) include methyl groups, ethyl groups, propyl groups, butyl groups, pentyl groups, hexyl groups, and similar alkyl groups; phenyl groups, tolyl groups, xylyl groups, and similar aryl groups; benzyl groups, phenethyl groups, and similar aralkyl groups; and 3-chloropropyl groups, 3,3,3-trifluoropropyl groups, and similar halogenated alkyl groups. Of these, methyl groups are preferable. A kinetic viscosity at 25° C. of component (B-1) is not particularly limited, but is preferably within a range of from 1 to 1,000,000 mm²/s.

Examples of the organopolysiloxane for component (B-1) include copolymers of dimethylsiloxane and methyl hydrogen siloxane capped at both molecular terminals with trimethylsiloxy groups, copolymers of methylsiloxane, diphenylsiloxane and methyl hydrogen siloxane capped at both molecular terminals with trimethylsiloxy groups, and mixtures thereof.

A content of component (B-1) is an amount such that a molar ratio of silicon-bonded hydrogen atoms in component (B-1) to silicon-bonded hydrogen atoms in component (B) is within a range of from 0.05 to 1.00, preferably within a range of from 0.07 to 0.90, and more preferably within a range of from 0.10 to 0.70. This is because if the content of component (B-1) falls within the above-mentioned range, the obtained two-part curable liquid silicone rubber composition exhibits sufficient curability and a silicone rubber obtained by curing the two-part curable liquid silicone rubber composition exhibits excellent mechanical characteristics.

The organopolysiloxane for component (B-2) has 2 silicon-bonded hydrogen atoms only at both molecular terminals. A molecular structure of component (B-2) is not particularly limited, but can be, for example, a resinous product having a straight chain, branched chain, cyclic or three dimensional mesh-like structure. Examples of silicon-bonded organic group in component (B-2) include methyl groups, ethyl groups, propyl groups, butyl groups, pentyl groups, hexyl groups, and similar alkyl groups; phenyl groups, tolyl groups, xylyl groups, and similar aryl groups; benzyl groups, phenethyl groups, and similar aralkyl groups; and 3-chloropropyl groups, 3,3,3-trifluoropropyl groups, and similar halogenated alkyl groups. Of these, methyl groups are preferable. A kinetic viscosity at 25° C. of component (B-2) is not particularly limited, but is preferably within a range of from 1 to 1,000,000 mm²/s.

Examples of the organopolysiloxane for component (B-2) include dimethylpolysiloxanes capped at both molecular terminals with dimethylhydrogensiloxy groups, copolymers of dimethylsiloxane and methylphenylsiloxane capped at both molecular terminals with dimethylhydrogensiloxy groups, and mixtures of two or more of these organopolysiloxanes.

A content of component (B-2) is an amount such that a molar ratio of silicon-bonded hydrogen atoms in component (B-2) to silicon-bonded hydrogen atoms in component (B) is within a range of from 0 to 0.95, preferably within a range of from 0.10 to 0.93, and more preferably within a range of from 0.30 to 0.90. This is because if the content of component (B-2) falls within the above-mentioned range, the obtained two-part curable liquid silicone rubber composition exhibits sufficient curability and a silicone rubber obtained by curing the two-part curable liquid silicone rubber composition exhibits excellent mechanical characteristics.

Component (B-1) and/or (B-2) is compounded only in the separately stored second liquid composition, and is preferably not simultaneously compounded with component (D) described below and stored.

Component (C) is a calcium carbonate powder to enhance adhesion of the present composition to silicone rubber. A BET specific surface area of component (C) is not particularly limited, but is preferably from 5 to 50 m²/g, and more preferably from 10 to 50 m²/g. Examples of the calcium carbonate powders for component (C) include heavy or dry-ground calcium carbonate powder, light or precipitated calcium carbonate powder, and these calcium carbonate powders surface-treated with fatty acids, resin acids, or similar organic acids. Of these, light or precipitated calcium carbonate powders are preferable, in particular, those that are surface-treated with fatty acids, resin acids, or similar organic acids.

A content of component (C) is within a range of from 1 to 200 parts by mass, preferably within a range of from 5 to 200 parts by mass, and more preferably within a range of from 10 to 100 parts by mass per 100 parts by mass of component (A). This is because if the content of component (C) is below the lower limit of the range described above, adhesion of the present composition to silicone rubber will tend to decline and, on the other hand, if above the upper limit of the range described above, it will be difficult to prepare a uniform silicone rubber composition.

Component (D) is a platinum-based catalyst to accelerate curing of the present composition. Examples of the platinum-based catalyst for component (D) include fine platinum powders, platinum black, chloroplatinic acid, platinum tetrachloride, alcohol solution of chloroplatinic acid, platinum-olefin complexes, platinum-alkenylsiloxane complexes, platinum-carbonyl complexes, as well as powdered methyl methacrylate resins, polycarbonate resins, polystyrene resins, silicone resins, or similar thermoplastic organic resins in which the platinum-based catalyst is dispersed.

A content of component (D) is not particularly limited provided that it is sufficient to cure the present composition, but is preferably an amount such that the platinum metal in component (D) is within a range of from 0.01 to 500 parts by mass and more preferably within a range of from 0.1 to 100 parts by mass per 1,000,000 parts by mass of component (A).

Component (D) is compounded only in the separately stored first liquid composition, and is preferably not simultaneously compounded with component (B) described above and stored.

The first liquid composition and/or the second liquid composition may further comprise (E) a silica powder for enhancing the mechanical strength of the silicone rubber obtained by curing the composition. Examples of component (E) include fumed silica, precipitated silica, baked silica, crushed quartz, and the aforementioned silica powders surface-treated with organoalkoxysilanes, organohalosilanes, organosilazanes, or similar organosilicon compounds. In order to sufficiently improve the mechanical strength of the obtained adhesive cured product, a silica powder having a BET specific surface area of not less than 50 m²/g is preferably used as component (E).

A content of component (E) can be determined as desired, but in order to improve the mechanical strength of the obtained silicone rubber, is preferably within a range of from 1 to 100 parts by mass and more preferably within a range of from 1 to 50 parts by mass per 100 parts by mass of component (A) in the silicone rubber forming composition obtained by mixing the first liquid composition and the second liquid composition.

Additionally, the first liquid composition and/or the second liquid composition may comprise, as an optional component, fumed titanium oxide, diatomaceous earth, aluminum oxide, aluminosilicate, silver, nickel, or a similar inorganic filler; or the aforementioned inorganic fillers surface-treated with the organosilicon compound described above.

Additionally, examples of an adhesion-imparting agent that the first liquid composition and/or the second liquid composition may comprise, which enhances the adhesion properties thereof, include methyl trimethoxysilane, vinyl trimethoxysilane, allyltrimethoxysilane, 3-methacryloxypropyltrimethoxysilane, 3-glycidoxypropyltrimethoxysilane, 3-aminopropyltrimethoxysilane, N-(2-aminoethyl)-3-aminopropyl trimethoxysilane, bis(trimethoxysilyl)propane, bis(trimethoxysilyl)hexane, or a similar silane coupling agent; tetraethyl titanate, tetrapropyl titanate, tetrabutyl titanate, tetra(2-ethylhexyl) titanate, titanium ethyl acetonate, titanium acetyl acetonate, or a similar titanium compound; aluminum ethylacetoacetate diisopropylate, aluminum tris(ethylacetoacetate), alkylacetoacetate aluminum diisopropylate, aluminum tris(acetylacetonate), aluminum monoacetylacetonate bis(ethylacetoacetate), or a similar aluminum compound; and zirconium acetylacetonate, zirconium butoxyacetylacetonate, zirconium bisacetylacetonate, and zirconium ethylacetoacetate, or a similar zirconium compound. A content of these adhesion-imparting agents is not particularly limited, but is preferably within a range of from 0.01 to 10 parts by mass per 100 parts by mass of component (A) in the silicone rubber forming composition obtained by mixing the first liquid composition and the second liquid composition.

Furthermore, examples of a curing inhibitor that the first liquid composition and/or the second liquid composition preferably comprises in order to enhance the storage stability and handling/workability thereof include 2-methyl-3-butyn-2-ol, 3,5-dimethyl-1-hexyn-3-ol, 2-phenyl-3-butyn-2-ol, ethynylcyclohexanol, or similar acetylene-based compounds; 3-methyl-3-penten-1-yne, 3,5-dimethyl-3-hexen-1-yne, or similar en-yne compounds; 1,3,5,7-tetramethyl-1,3,5,7-tetravinylcyclotetrasiloxane, 1,3,5,7-tetramethyl-1,3,5,7-tetrahexenylcyclotetrasiloxane, methylvinylsiloxane capped at both molecular terminals with silanol groups, methylvinylsiloxane-dimethylsiloxane copolymers capped at both molecular terminals with silanol groups, or similar organosiloxane compounds having 5 mass % or more vinyl groups in a molecule; benzotriazole or similar triazoles, phosphines, mercaptans, hydrazines, or other curing inhibitors.

A content of these curing inhibitors is not particularly limited, but is preferably within a range of from 0.001 to 5 parts by mass per 100 parts by mass of component (A) in the silicone rubber forming composition obtained by mixing the first liquid composition and the second liquid composition.

The two-part curable liquid silicone rubber composition of the present invention comprises the separately stored first liquid composition comprising components (A), (C), and (D), but not (B-1) and/or (B-2), and the second liquid composition comprising components (A), (B-1) and/or (B-2), and (C), but not (D). The first liquid composition and the second liquid composition are preferably mixed at a mixture ratio of 1:1 (expressed as a volume ratio) and used as the silicone rubber forming composition. This is because in cases where the mixture ratio is unintentionally changed at any type of flow rate measurement device attached to a dispensing device such as a gear pump, pail pump, drum pump, or the like, changes in the formulation of the silicone rubber forming composition will be relatively small.

Moreover, a difference in viscosity between the first liquid composition and the second liquid composition is preferably small. This is because a small difference in viscosity leads to the advantage of maintaining a constant mixture ratio of the first liquid composition and the second liquid composition at any type of flow rate measurement device attached to a dispensing device such as a gear pump, pail pump, drum pump, or the like.

With the two-part curable liquid silicone rubber composition of the present invention, the first liquid composition and the second liquid composition are stored separately. Silicone rubber formation is provided by producing a silicone rubber forming composition by mixing the first liquid composition and the second liquid composition immediately prior to use. Preferably, an apparatus is used that comprises: a first tank in which the first liquid composition is stored and a second tank in which the second liquid composition is stored; a feeding apparatus that supplies a specific amount of each liquid composition to a mixing device via a dispensing device and a flow rate control device connected to each of the tanks; a mixing device such as a pin mixer or similar dynamic mixer or static mixer for mixing the first liquid composition and the second liquid composition; and a device for dispensing the silicone rubber forming composition obtained from the mixing device.

Methods for preparing the first liquid composition and the second liquid composition are not particularly limited, and these liquid compositions can be prepared by mixing components (A) to (E) and, as necessary, additional optional components. In cases when it is necessary to add these other optional components, these other optional components may be added when preparing the base compound or, alternately, in cases when these other optional components degrade as a result of hot mixing, are preferably added when adding components (B) to (E). Additionally, when preparing the base compound, the organosilicon compound may be added and component (E) may be subjected to an in-situ surface treatment. The composition may be prepared using a two-roll mill, a kneader mixer, a Ross® mixer, or similar known mixing device.

### EXAMPLES

Practical Examples and Comparative Examples of the silicone rubber composition of the present invention are described in detail below. Note that the viscosity in the Examples is the value at 25° C. and silicone rubber characteristics are measured as follows.

### [Physical Properties of the Silicone Rubber]

The silicone rubber was fabricated by allowing the silicone rubber composition to sit at rest for one day at 25° C. Asker C hardness of this silicone rubber is measured using a type C hardness tester as stipulated in JIS K 7312. Additionally, a sample having a deformed grip portion in the form of a No. 7 dumbbell stipulated by JIS K6251 was fabricated by allowing this silicone rubber composition to sit at rest for one day at 25° C. Next, the tensile strength and elongation of the sample was measured in accordance with the methods stipulated in JIS K6251.

### [Adhesion Strength to Silicone Rubber]

Adhesion strength of the silicone rubber composition to silicone rubber was measured as follows in accordance with the method stipulated in JIS K 6854. Specifically, the silicone rubber composition was applied in the form of a 50 mm-wide strip onto a nylon base material coated with 30 g/m² of silicone rubber. Then, a silicone rubber-coated nylon tape was overlaid on the nylon tape on which the silicone rubber composition was applied so that the composition formed a 0.5 mm-thick layer between the silicone rubber-coated nylon tapes. The coated base material was allowed to sit at rest for one day at 25° C. to cure the composition, whereby a sample was fabricated. Then, adhesive strength to silicone rubber was measured by subjecting the obtained silicone rubber-coated nylon tape to a T-shaped peeling test at a peeling speed of 200 mm/min.

### Practical Example 1

A first liquid composition was prepared by mixing: 98.0 parts by mass of a dimethylpolysiloxane capped at both molecular terminals with dimethylvinylsiloxy groups and having a viscosity of 40,000 mPa·s; 2.0 parts by mass of a dimethylpolysiloxane having vinyl groups at both molecular terminals and on the side molecular chains and having a viscosity of 350 mPa·s (vinyl group content: 0.93% by mass, average number of vinyl groups on the molecular side chains: 2.5); 3.0 parts by mass of fumed silica surface-treated with dimethyldichlorosilane and having a BET specific surface area of about 110 m²/g; 25 parts by mass of precipitated calcium carbonate powder surface-treated with fatty acids and having a BET specific surface area of 18 m²/g (Hakuenka CCR, manufactured by Shiraishi Kogyo Kaisha, Ltd.); 3.0 parts by mass of dimethylpolysiloxane capped at both molecular terminals with silanol groups and having a viscosity of 40 mPa·s; a 1,3-divinyltetramethyl disiloxane solution of a 1,3-divinyltetramethyl disiloxane platinum complex (included at an amount such that the amount of platinum metal in the catalyst is 50 parts by mass per 1,000,000 parts by mass of the present composition); and 2.0 parts by mass of a pigment paste in which 40 parts by mass of red iron oxide are compounded with 60 parts by mass of a dimethylpolysiloxane capped at both molecular terminals with dimethylvinylsiloxy groups and having a viscosity of 10,000 mPa·s.

In addition, a second liquid composition was prepared by mixing: 98.9 parts by mass of a dimethylpolysiloxane capped at both molecular terminals with dimethylvinylsiloxy groups and having a viscosity of 40,000 mPa·s; 3.0 parts by mass of fumed silica surface-treated with dimethyldichlorosilane and having a BET specific surface area of approximately 110 m²/g; 30 parts by mass of a precipitated calcium carbonate powder surface-treated with a fatty acid and having a BET specific surface area of 18 m²/g (Hakuenka CCR manufactured by Shiraishi Kogyo Kaisha, Ltd.); 6.0 parts by mass of a dimethylpolysiloxane capped at both molecular terminals with silanol groups and having a viscosity of 40 mPa·s; 1.05 parts by mass of a copolymer of dimethylsiloxane and methylhydrogensiloxane capped at both molecular terminals with trimethylsiloxy groups, which had a kinetic viscosity of 21 mm²/s, had an average of 1.9 silicon-bonded hydrogen atoms in a molecule in side chains and had a silicon-bonded hydrogen atom content of approximately 0.098% by mass (at an amount where the molar ratio of silicon-bonded hydrogen atoms in the mixture relative to silicon-bonded vinyl groups contained in the total composition was 0.10); and 5.10 parts by mass of a dimethylpolysiloxane capped at both molecular terminals with dimethylhydrogensiloxy groups, which had a kinetic viscosity of 10 mm²/s and a silicon-bonded hydrogen atom content of approximately 0.016% by mass (at an amount where the molar ratio of silicon-bonded hydrogen atoms in the mixture relative to silicon-bonded vinyl groups contained in the total composition was 0.90).

Silicone rubber compositions were mixed and prepared such that mass ratios of the first liquid composition to the second liquid composition were 110:100, 100:100, and 100:110. The physical properties and adhesive strength and adhesion ratio of the silicone rubber obtained by curing this silicone rubber composition were measured and the results thereof were recorded in Table 1.

### Practical Example 2

A third liquid composition was prepared in the same way as in Practical Example 1, except that 0.90 parts by mass of a copolymer of dimethylsiloxane and methylhydrogensiloxane capped at both molecular terminals with trimethylsiloxy groups, which had a kinetic viscosity of 19 mm²/s, had an average of 2.0 silicon-bonded hydrogen atoms in a molecule in side chains and had a silicon-bonded hydrogen atom content of approximately 0.12% by mass, was used instead of 1.05 parts by mass of a copolymer of dimethylsiloxane and methylhydrogensiloxane capped at both molecular terminals with trimethylsiloxy groups, which had a kinetic viscosity of 21 mm²/s, had an average of 1.9 silicon-bonded hydrogen atoms in a molecule in side chains and had a silicon-bonded hydrogen atom content of approximately 0.098% by mass, which was used in the second liquid composition in Practical Example 1.

Silicone rubber compositions were mixed and prepared such that mass ratios of the first liquid composition of Practical Example 1 to the third liquid composition were 110:100, 100:100, and 100:110. The physical properties and adhesive strength and adhesion ratio of the silicone rubber obtained by curing this silicone rubber composition were measured and the results thereof were recorded in Table 1.

### Practical Example 3

A fourth liquid composition was prepared in the same way as in Practical Example 1, except that a mixture of 0.70 parts by mass of a copolymer of dimethylsiloxane and methylhydrogensiloxane capped at both molecular terminals with trimethylsiloxy groups, which had a kinetic viscosity of 21 mm²/s, had an average of 1.9 silicon-bonded hydrogen atoms in a molecule in side chains and had a silicon-bonded hydrogen atom content of approximately 0.098% by mass, and 0.15 parts by mass of a copolymer of dimethylsiloxane and methylhydrogensiloxane capped at both molecular terminals with trimethylsiloxy groups, which had a kinetic viscosity of 3 mm²/s, had an average of 1.0 silicon-bonded hydrogen atoms in a molecule in side chains and had a silicon-bonded hydrogen atom content of approximately 0.25% by mass, was used instead of 1.05 parts by mass of a copolymer of dimethylsiloxane and methylhydrogensiloxane capped at both molecular terminals with trimethylsiloxy groups, which had a kinetic viscosity of 21 mm²/s, had an average of 1.9 silicon-bonded hydrogen atoms in a molecule in side chains and had a silicon-bonded hydrogen atom content of approximately 0.098% by mass, which was used in the second liquid composition in Practical Example 1.

Silicone rubber compositions were mixed and prepared such that mass ratios of the first liquid composition of Practical Example 1 to the fourth liquid composition were 110:100, 100:100, and 100:110. The physical properties and adhesive strength and adhesion ratio of the silicone rubber obtained by curing this silicone rubber composition were measured and the results thereof were recorded in Table 1.

### Practical Example 4

A fifth liquid composition was prepared in the same way as in Practical Example 1, except that the amount of the copolymer of dimethylsiloxane and methylhydrogensiloxane capped at both molecular terminals with trimethylsiloxy groups, which had a kinetic viscosity of 21 mm²/s, had an average of 1.9 silicon-bonded hydrogen atoms in a molecule in side chains and had a silicon-bonded hydrogen atom content of approximately 0.098% by mass, which was used in the second liquid composition in Practical Example 1, was changed from 1.05 parts by mass to 2.84 parts by mass and the amount of the dimethylpolysiloxane capped at both molecular terminals with dimethylhydrogensiloxy groups, which had a kinetic viscosity of 10 mm²/s and a silicon-bonded hydrogen atom content of approximately 0.016% by mass, which was used in the second liquid composition in Practical Example 1, was changed from 5.10 parts by mass to 4.03 parts by mass.

Silicone rubber compositions were mixed and prepared such that mass ratios of the first liquid composition of Practical Example 1 to the fifth liquid composition were 110:100, 100:100, and 100:110. The physical properties and adhesive strength and adhesion ratio of the silicone rubber obtained by curing this silicone rubber composition were measured and the results thereof were recorded in Table 1.

### Practical Example 5

A sixth liquid composition was prepared in the same way as in Practical Example 1, except that the amount of the copolymer of dimethylsiloxane and methylhydrogensiloxane capped at both molecular terminals with trimethylsiloxy groups, which had a kinetic viscosity of 21 mm²/s, had an average of 1.9 silicon-bonded hydrogen atoms in a molecule in side chains and had a silicon-bonded hydrogen atom content of approximately 0.098% by mass, which was used in the second liquid composition in Practical Example 1, was changed from 1.05 parts by mass to 4.71 parts by mass and the amount of the dimethylpolysiloxane capped at both molecular terminals with dimethylhydrogensiloxy groups, which had a kinetic viscosity of 10 mm²/s and a silicon-bonded hydrogen atom content of approximately 0.16% by mass, which was used in the second liquid composition in Practical Example 1, was changed from 5.10 parts by mass to 2.88 parts by mass.

Silicone rubber compositions were mixed and prepared such that mass ratios of the first liquid composition of Practical Example 1 to the sixth liquid composition were 110:100, 100:100, and 100:110. The physical properties and adhesive strength and adhesion ratio of the silicone rubber obtained by curing this silicone rubber composition were measured and the results thereof were recorded in Table 1.

### Practical Example 6

A seventh liquid composition was prepared in the same way as in Practical Example 1, except that the amount of the copolymer of dimethylsiloxane and methylhydrogensiloxane capped at both molecular terminals with trimethylsiloxy groups, which had a kinetic viscosity of 21 mm²/s, had an average of 1.9 silicon-bonded hydrogen atoms in a molecule in side chains and had a silicon-bonded hydrogen atom content of approximately 0.098% by mass, which was used in the second liquid composition in Practical Example 1, was changed from 1.05 parts by mass to 6.59 parts by mass and the amount of the dimethylpolysiloxane capped at both molecular terminals with dimethylhydrogensiloxy groups, which had a kinetic viscosity of 10 mm²/s and a silicon-bonded hydrogen atom content of approximately 0.16% by mass, which was used in the second liquid composition in Practical Example 1, was changed from 5.10 parts by mass to 1.73 parts by mass.

Silicone rubber compositions were mixed and prepared such that mass ratios of the first liquid composition of Practical Example 1 to the seventh liquid composition were 110:100, 100:100, and 100:110. The physical properties and adhesive strength and adhesion ratio of the silicone rubber obtained by curing this silicone rubber composition were measured and the results thereof were recorded in Table 1.

### Practical Example 7

An eighth liquid composition was prepared in the same way as in Practical Example 1, except that the amount of the copolymer of dimethylsiloxane and methylhydrogensiloxane capped at both molecular terminals with trimethylsiloxy groups, which had a kinetic viscosity of 21 mm²/s, had an average of 1.9 silicon-bonded hydrogen atoms in a molecule in side chains and had a silicon-bonded hydrogen atom content of approximately 0.098% by mass, which was used in the second liquid composition in Practical Example 1, was changed from 1.05 parts by mass to 9.30 parts by mass and the amount of the dimethylpolysiloxane capped at both molecular terminals with dimethylhydrogensiloxy groups, which had a kinetic viscosity of 10 mm²/s and a silicon-bonded hydrogen atom content of approximately 0.16% by mass, which was used in the second liquid composition in Practical Example 1, was changed from 5.10 parts by mass to 0 parts by mass.

Silicone rubber compositions were mixed and prepared such that mass ratios of the first liquid composition of Practical Example 1 to the eighth liquid composition were 110:100, 100:100, and 100:110. The physical properties and adhesive strength and adhesion ratio of the silicone rubber obtained by curing this silicone rubber composition were measured and the results thereof were recorded in Table 1.

### Comparative Example 1

A ninth liquid composition was prepared in the same way as in Practical Example 1, except that 0.52 parts by mass of a copolymer of dimethylsiloxane and methylhydrogensiloxane capped at both molecular terminals with trimethylsiloxy groups, which had a kinetic viscosity of 12 mm²/s, had an average of 2.9 silicon-bonded hydrogen atoms in a molecule in side chains and had a silicon-bonded hydrogen atom content of approximately 0.21% by mass, was used instead of 1.05 parts by mass of a copolymer of dimethylsiloxane and methylhydrogensiloxane capped at both molecular terminals with trimethylsiloxy groups, which had a kinetic viscosity of 21 mm²/s, had an average of 1.9 silicon-bonded hydrogen atoms in a molecule in side chains and had a silicon-bonded hydrogen atom content of approximately 0.098% by mass, which was used in the second liquid composition in Practical Example 1.

Silicone rubber compositions were mixed and prepared such that mass ratios of the first liquid composition of Practical Example 1 to the ninth liquid composition were 110:100, 100:100, and 100:110. The physical properties and adhesive strength and adhesion ratio of the silicone rubber obtained by curing this silicone rubber composition were measured and the results thereof were recorded in Table 1.

### Comparative Example 2

A tenth liquid composition was prepared in the same way as in Practical Example 1, except that 0.26 parts by mass of a copolymer of dimethylsiloxane and methylhydrogensiloxane capped at both molecular terminals with trimethylsiloxy groups, which had a kinetic viscosity of 12 mm²/s, had an average of 2.9 silicon-bonded hydrogen atoms in a molecule in side chains and had a silicon-bonded hydrogen atom content of approximately 0.21% by mass, and 0.45 parts by mass of a copolymer of dimethylsiloxane and methyl hydrogen siloxane capped at both molecular terminals with trimethylsiloxy groups, which had a kinetic viscosity of 19 mm²/s, had an average of 2.0 silicon-bonded hydrogen atoms in a molecule in side chains and had a silicon-bonded hydrogen atom content of approximately 0.12% by mass, was used instead of 1.05 parts by mass of a copolymer of dimethylsiloxane and methylhydrogensiloxane capped at both molecular terminals with trimethylsiloxy groups, which had a kinetic viscosity of 21 mm²/s, had an average of 1.9 silicon-bonded hydrogen atoms in a molecule in side chains and had a silicon-bonded hydrogen atom content of approximately 0.098% by mass, which was used in the second liquid composition in Practical Example 1.

Silicone rubber compositions were mixed and prepared such that mass ratios of the first liquid composition of Practical Example 1 to the tenth liquid composition were 110:100, 100:100, and 100:110. The physical properties and adhesive strength and adhesion ratio of the silicone rubber obtained by curing this silicone rubber composition were measured and the results thereof were recorded in Table 1.

### Comparative Example 3

An eleventh liquid composition was prepared in the same way as in Practical Example 1, except that the amount of the copolymer of dimethylsiloxane and methylhydrogensiloxane capped at both molecular terminals with trimethylsiloxy groups, which had a kinetic viscosity of 21 mm²/s, had an average of 1.9 silicon-bonded hydrogen atoms in a molecule in side chains and had a silicon-bonded hydrogen atom content of approximately 0.098% by mass, which was used in the second liquid composition in Practical Example 1, was changed from 1.05 parts by mass to 0 parts by mass and the amount of the dimethylpolysiloxane capped at both molecular terminals with dimethylhydrogensiloxy groups, which had a kinetic viscosity of 10 mm²/s and a silicon-bonded hydrogen atom content of approximately 0.16% by mass, which was used in the second liquid composition in Practical Example 1, was changed from 5.10 parts by mass to 5.80 parts by mass.

Silicone rubber compositions were mixed and prepared such that mass ratios of the first liquid composition of Practical Example 1 to the eleventh liquid composition were 110:100, 100:100, and 100:110. The physical properties and adhesive strength and adhesion ratio of the silicone rubber obtained by curing this silicone rubber composition were measured and the results thereof were recorded in Table 1.

TABLE 1

| | Mixing ratio | | | | | |
|---|---|---|---|---|---|---|
| | (First | | | | | |
| | composition/ | Hardness | Tensile | | Adhesive | Adhesion |
| | second | (Asker C | strength | Elongation | strength | ratio |
| | composition) | hardness) | (MPa) | (%) | (N/cm) | (%) |
| Practical | 110/100 | 24 | 0.14 | 4600 | 8.2 | 100 |
| Example 1 | 100/100 | 27 | 0.16 | 4300 | 7.9 | 100 |
| | 100/110 | 24 | 0.22 | 3600 | 8.2 | 100 |
| Practical | 110/100 | 24 | 0.24 | 4900 | 10.4 | 100 |
| Example 2 | 100/100 | 25 | 0.19 | 3700 | 9.9 | 100 |
| | 100/110 | 28 | 0.19 | 4200 | 11.3 | 100 |
| Practical | 110/100 | 24 | 0.08 | 5000 | 4.2 | 100 |
| Example 3 | 100/100 | 24 | 0.10 | 4200 | 4.8 | 100 |
| | 100/110 | 22 | 0.07 | 3700 | 4.6 | 100 |
| Practical | 110/100 | 20 | 1.28 | 2350 | 30.0 | 100 |
| Example 4 | 100/100 | 22 | 1.09 | 2400 | 29.3 | 100 |
| | 100/110 | 23 | 1.06 | 2300 | 29.9 | 100 |
| Practical | 110/100 | 25 | 2.48 | 1900 | 34.1 | 100 |
| Example 5 | 100/100 | 26 | 2.02 | 1900 | 32.4 | 100 |
| | 100/110 | 28 | 2.22 | 2000 | 31.0 | 100 |
| Practical | 110/100 | 26 | 2.06 | 1600 | 30.1 | 100 |
| Example 6 | 100/100 | 27 | 1.92 | 1700 | 35.3 | 100 |
| | 100/110 | 28 | 1.75 | 1600 | 31.6 | 100 |
| Practical | 110/100 | 25 | 1.54 | 1300 | 31.6 | 100 |
| Example 7 | 100/100 | 27 | 1.78 | 1400 | 27.7 | 100 |
| | 100/110 | 25 | 1.64 | 1400 | 29.1 | 100 |
| Comparative | 110/100 | 28 | 0.60 | 3000 | 22.7 | 100 |
| Example 1 | 100/100 | 27 | 0.48 | 2900 | 20.8 | 50 |
| | 100/110 | 24 | 0.36 | 2750 | 15.2 | 10 |
| Comparative | 110/100 | 28 | 0.57 | 3800 | 18.9 | 100 |
| Example 2 | 100/100 | 27 | 0.38 | 3500 | 15.1 | 100 |
| | 100/110 | 24 | 0.37 | 3000 | 14.6 | 20 |
| Comparative | 110/100 | 21 | Below | 600 | 0.6 | 0 |
| Example 3 | 100/100 | 24 | detection | 800 | 0.8 | 0 |
| | 100/110 | 19 | limit | 1700 | 1.2 | 0 |

As shown in Table 1, no significant changes in physical properties were seen at mixing ratios of 110:100, 100:100 and 100:110 and the adhesion ratio was maintained at 100% in Practical Examples 1 to 7. However, Comparative Examples 1 to 3 shown in Table 1 exhibited changes in physical properties, such as a deterioration in adhesive strength or adhesion ratio.

### INDUSTRIAL APPLICABILITY

The two-part curable liquid silicone rubber composition of the present Invention is useful as an adhesive or sealer for a silicone rubber coated fabric.

1. A two-part curable liquid silicone rubber composition composed of a first liquid composition and a second liquid composition, which are stored separately and yield upon mixing a silicone rubber forming composition comprising:
(A) 100 parts by mass of a diorganopolysiloxane having an average of at least 2 alkenyl groups in a molecule;
(B) a silicon-bonded hydrogen atom-containing organopolysiloxane composed of (B-1) and (B-2) described below in an amount such that a molar ratio of silicon-bonded hydrogen atoms in component (B) relative to alkenyl groups in component (A) is from 0.01 to 20;
(B-1) an organopolysiloxane having an average of not more than 2 silicon-bonded hydrogen atoms in a molecule only in side molecular chains in an amount such that a molar ratio of silicon-bonded hydrogen atoms in component (B-1) relative to silicon-bonded hydrogen atoms in component (B) is from 0.05 to 1.00,
(B-2) an organopolysiloxane having 2 silicon-bonded hydrogen atoms only at both molecular terminals in an amount such that a molar ratio of silicon-bonded hydrogen atoms in component (B-2) relative to silicon-bonded hydrogen atoms in component (B) is from 0.00 to 0.95,
(C) from 1 to 200 parts by mass of a calcium carbonate powder; and
(D) a platinum-based catalyst in an amount required to cure the present composition, the first liquid composition comprising components (A), (C), and (D), but not (B-1) and (B-2), and the second liquid composition comprising components (A), (B-1), (B-2), and (C), but not (D).

2. The two-part curable liquid silicone rubber composition according to claim 1, wherein a mixture ratio expressed as a volume ratio of the separately stored first liquid composition and second liquid composition is 1:1.

3. The two-part curable liquid silicone rubber composition according to claim 1, wherein component (C) is a light or precipitated calcium carbonate powder.

4. The two-part curable liquid silicone rubber composition according to claim 1, wherein the first composition and/or the second composition further comprises (E) an amorphous silica powder in an amount of from 0.1 to 100 parts by mass per 100 parts by mass of component (A).

5. The two-part curable liquid silicone rubber composition according to claim 1 that is an adhesive for a silicone rubber coated fabric.

6. The two-part curable liquid silicone rubber composition according to claim 1 that is a sealer for a silicone rubber coated fabric.

7. The two-part curable liquid silicone rubber composition according to claim 2, wherein component (C) is a light or precipitated calcium carbonate powder.

8. The two-part curable liquid silicone rubber composition according to claim 2, wherein the first composition and/or the second composition further comprises (E) an amorphous silica powder in an amount of from 0.1 to 100 parts by mass per 100 parts by mass of component (A).

9. The two-part curable liquid silicone rubber composition according to claim 3, wherein component (C) has a BET specific surface area of from 5 to 50 m²/g.

10. The two-part curable liquid silicone rubber composition according to claim 4, wherein component (E) has a BET specific surface area of not less than 50 m²/g.

11. An adhesive comprising a cured product of the two-part curable liquid silicone rubber composition according to claim 1.

12. A sealer comprising a cured product of the two-part curable liquid silicone rubber composition according to claim 1.

13. A silicone rubber coated fabric comprising a cured product of the two-part curable liquid silicone rubber composition according to claim 1.

14. The silicone rubber coated fabric according to claim 13, wherein the cured product is an adhesive, a sealer, or combination thereof.
